(19) United States
(12) Patent Application Publication
(10) Pub. No.: US 2002/0057873 A1
(43) Pub. Date: May 16, 2002

(54) Laser collimator for a free space optical link

(75) Inventors: Li Wu, Fuxing Investment District (CN); Jiwu Ling, Fuxing Investment District (CN); Chaoping Chen, Fuxing Investment District (CN); Jinhua Huang, Fuxing Investment District (CN); Shancong Zhang, Fuxing Investment District (CN); Derwyn C. Johnson, Nepean (CA); Neil Teitelbaum, Ottawa (CA)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: JDS Uniphase Corporation, San Jose, CA

(21) Appl. No.: 09/981,122

(22) Filed: Oct. 17, 2001

(30) Foreign Application Priority Data
Oct. 18, 2000 (CN) 00240685.3

(51) Int. Cl. G02B 6/32

(52) U.S. Cl. 385/33

(57) ABSTRACT

The invention relates to the design of laser collimators for free space through-the-air optical links. The laser collimator provides means for expanding the diameter of a light beam emitted from the end of a monomode optical fiber that has been optical coupled to a semiconductor laser diode and projecting through free space the expanded beam as a low divergence beam of substantially parallel rays. The laser collimators disclosed are compact, simple to make, and overcome many of the deleterious effects that result from the requirement that the air-glass surface terminating the end of the monomode fiber coupled to the semiconductor laser is not normal to the axis of the optical fiber. Means are also disclosed for increasing the divergence of the cone of light emitted from the tip of an optical fiber thereby enabling the construction of laser collimators with larger expansion ratios in a compact size.

### FIELD OF THE INVENTION

The present application relates to light beam expanders or collimating devices for expanding the beam diameter of light from a laser source and projecting it as a parallel beam of light.

### BACKGROUND OF THE INVENTION

Free space optical links are an alternative to optical fibers to provide a high bandwidth communication channel between two locations. Such links are particularly cost effective when the installation of the hard wired optical fiber link is very costly as for example between two offices located in neighboring high rise buildings in a city. The implementation of free space optical links requires the transmitter to send a large diameter low divergence beam of light, for example a beam of a few centimeters, that can be easily projected and aligned on the receiver at the other end of the link. Typically, the light output from a laser source has a small beam diameter. Thus a beam expander or laser collimator is required to transform the light output from the laser source into a larger diameter low divergence beam of light, wherein the rays are substantially parallel. This invention is concerned with an improved design for these laser collimators.

Several factors need to be considered in the design of a laser collimator. Firstly, it is desirable to use as a light source, a semiconductor laser which has been optically coupled by way of being pigtailed with a single mode optical fiber. The light output from a non-pigtailed semiconductor laser is far from ideal. Due to the very thin and wide highly asymmetrical cross section of the semiconductor lasing medium, the light output is elliptical in shape and highly divergent in the direction normal to the plane of the lasing media. On the other hand, the output from a fiber pigtailed laser has a circular beam cross section with a Gaussian intensity profile and the divergence is well defined by the confinement angle T_{confinement} which is given by arccos (n_{clad}/n_{core}) where n_{core} and n_{clad} are respectively the refractive indices of the core and cladding the of the single mode fiber. Furthermore, this type of laser is being mass produced, for fiber optic telecommunications applications thereby providing a supply of high quality light sources at a low cost for through-the-air applications. Another desirable requirement is that the laser source operate in the 1500 nm wavelength region. In this wavelength region, the power limits set by the eye safety standards are significantly higher than for lasers operating at shorter wavelengths. Finally it is desirable that the laser collimator be simple, compact and light-weight for mounting on a beam steering device for pointing the laser beam at a receiver.

### BRIEF DESCRIPTION OF THE DRAWINGS

The invention will be described in greater detail with reference to the accompanying drawings which represent preferred embodiments thereof, wherein:

FIG. 1 is a design for a laser collimator.

FIG. 2 is a schematic diagram of the laser collimator in accordance with the present invention.

FIG. 3 is an expanded view of the mounting sleeve of the laser collimator of FIG. 2.

FIG. 4 is another embodiment or the input section of the laser collimator in accordance with this invention.

FIG. 5 is another embodiment of the input section of the laser collimator in accordance with this invention.

FIG. 6 is another embodiment of the input section of the laser collimator in accordance with this invention.

### DETAILED DESCRIPTION

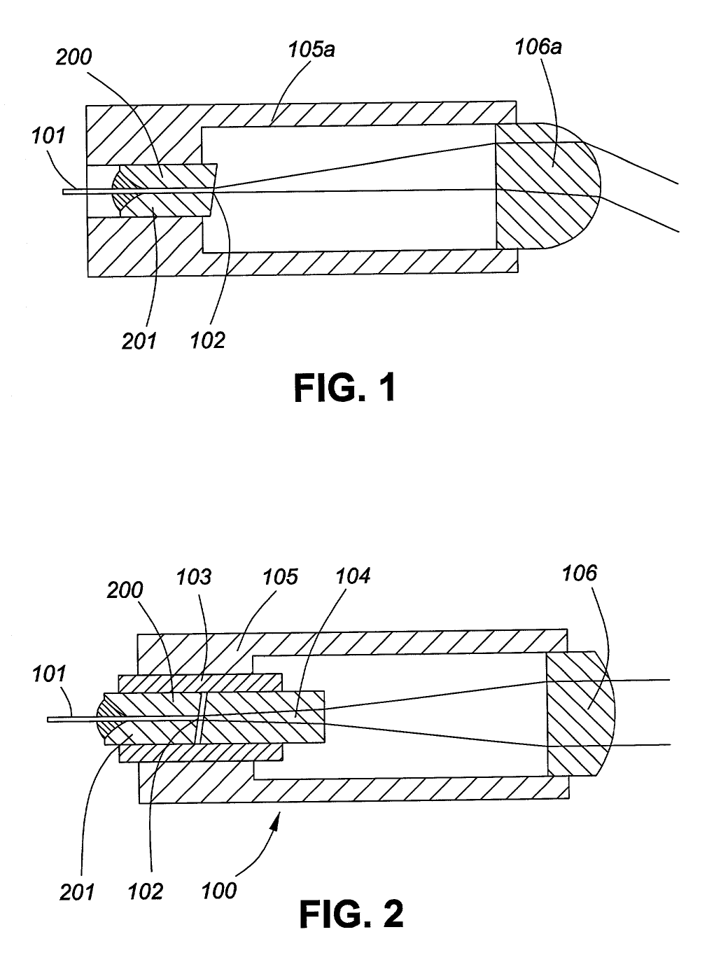

FIG. 1 shows a design for a laser collimator. A cylindrical collimator holder 105a housing securely holding an optical fiber pigtail 200 which includes capillary tube 201 an optical fiber 101 residing the capillary tube. The collimator holder 105a is shown having a circular hole at one end in which the tip 102 of optical fiber 101 of the optical fiber pigtail 200 is inserted and fastened and another cylindrical hole at the other end of the holder 105a in which a plano-convex lens 106a is mounted. The center axis of the lens 106a is aligned with the axis of the optical fiber 101 and the end of the optical fiber tip 102 is located at the focus of the lens 106a. The light emerging from the optical fiber tip 102 radiates into a cone of diverging light as shown. The half angle of the cone depends on the optical fiber numerical aperture. In the case of standard telecommunications monomode optical fiber, the half angle is nominally 10 to 12 degrees. The light cone falls on the plano-convex lens 106a and is refracted into a parallel beam of larger diameter. The diameter of this beam depends on the distance between the lens 106a and the optical fiber end and the half angle of the cone of light.

In the design for the laser collimator shown in FIG. 1, it is necessary to terminate the end of the optical fiber tip with a flat planar surface that is not normal to the axis of the optical fiber. Typically, this flat surface on the slanted end of the optical fiber pigtail makes angle of 82 degrees with the optical fiber axis. The reason the optical fiber tip cannot be terminated with a surface normal to the fiber axis is that Fresnel back reflection of the laser light at the glass-air interface is coupled back into the laser and disturbs the laser operation. Several detrimental effects arise because of this angled surface. The cone of radiated light is deflected so its axis is no longer aligned with the optical fiber-lens axis. In FIG. 1 this deflection is shown as deflecting the beam upward. A consequence of this deflection in the light cone is that the plano-convex lens 106a is much more complicated and costly to fabricate than a simple plano-convex lens such as lens 106 in FIG. 2. The lens 106a needs to be significantly larger than it would have to be if the cone of light were on axis because only part of the lens is being used. The flat surface of the plano-convex lens 106a is also not normal to the lens axis, but has been ground so that it is a 82 degree angle to the lens axis. Furthermore, the lens 106a must be mounted in the collimator holder and oriented so this surface is in parallel alignment with the fiber termination interface as shown in FIG. 1. Another shortcoming of the collimator is that light on passing through the lens is refracted into a parallel beam along a direction that does not correspond to the fiber-lens optical axis of the collimator. This feature of the collimator makes alignment of the optical path between the transmitter and the receiver more difficult. A final deleterious effect is that the light on traversing through the lens, passes near the lens edge where the light will experience increased spherical aberrations which means the focused spot size at the receiver will be larger than optimum.

An object of the present invention is to design a collimator for a pigtailed laser diode in which the direction of the radiated expanded beam is coincident with the collimator optical axis and to reduce the aberrations experienced by the light passing through the collimator. A further object of the invention is to provide ways to increase the half-angle of the cone of light radiated from the fiber tip so that a larger radiated beam diameter can be realized in a collimator of shorter length.

The present invention provides a means for overcoming the several deficiencies in the design for laser collimators shown in FIG. 1. Referring to FIG. 2, the collimator 100 in accordance with the invention has a collimator holder 105 having the shape of a cylindrical tube. The holder 105 is provided with a circular hole at one end in which a cylindrical mounting sleeve 103 can be inserted. The sleeve 103 contains two elements, an optical fiber pigtail 200 and light transmissive element in the form of a wedge shaped glass rod insert 104 having substantially no optical lensing power. The optical fiber pigtail 200 is typically fabricated by gluing a bare optical fiber 101 in a capillary tube 201 and polishing the end surface of the capillary tube 201 and the optical fiber tip 102 to have an 8 degree wedge angle. Optical fiber pigtails 200 are available commercially from Fujian JDSU CASIX, Inc. with a variety of different optical fibers including monomode optical fiber operating a wavelength of 1550 nm. The laser diode source, not shown in FIG. 2 is connected to the fiber pigtail 200 by fusion splicing the monomode fiber pigtail 101 of the fiber pigtail 200 to the monomode fiber pigtail of the laser diode, not shown in FIG. 2. At the other end of the collimator holder 105, another larger diameter hole is provided in which a plano-convex lens 106 is mounted. The axis of the lens 106 is inline with the axis of the optical fiber 101 and the lens 106 focal point is on the end of the optical fiber tip 102.

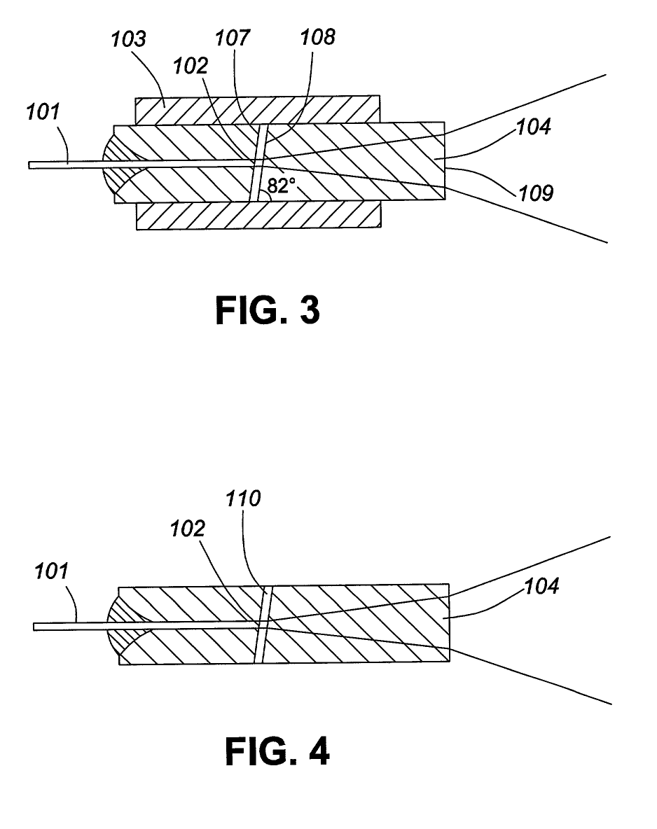

FIG. 3 is an expanded view of the sleeve 103 of the collimator. A glass rod insert 104 has a refractive index equal to the refractive index, n_{core} of the optical fiber. One end of the glass rod insert 104 is ground flat with the surface plane at an angle of 82 degrees to the rod axis. The other end of the glass rod insert 104 is flat with the surface plane normal to the fiber axis. The glass rod insert 104 is mounted in the sleeve 103 and oriented such that the angled surface of the insert 104 meshes with the angled surface of the optical fiber tip 102 and the glass rod insert 104 is pushed into the sleeve 103 of the collimator such that there is a small air gap between end of the optical fiber tip 102 and the end of the rod insert 102 as shown in FIG. 3. The glass rod insert 104 has the effect of straightening out the deflection of the cone of light radiating from the end of the fiber tip 102. In the air gap, the cone of light emerging from the optical fiber tip 102 still undergoes refraction and thus is deflected off the fiber axis, but because the air gap is thin, the diverging light cone does not propagate very far before it experiences a second refraction at the first surface of the rod insert 104, which straightens out the diverging light cone so that its axis is parallel the fiber axis and thus parallel to the optic axis of the collimator. Because the air gap is so thin, the offset of the axis of the diverging cone of light from the optical axis of the collimator is very small. Thus in the rod insert 104, the light propagates as an expanding cone with a half angle T_{confinement}, the confinement angle for the monomode fiber 101 and along an axis that is effectively coincident with the optic axis of the collimator. For a typical monomode fiber, T_{confinement} is nominally 8 degrees. When the diverging cone of light passes through the exit end of the glass rod insert 104, it experiences another refraction which increases the half-angle of the diverging cone of light to T_{acceptance}=arcsin (n_{core}×sinT_{confinement}). T_{acceptance} is also called the half acceptance angle of the monomode fiber and is nominally 12 degrees. The light emerging from the fiber tip 102 will experience Fresnel reflections at the fiber tip-air gap interface 107, the air gap-rod insert interface 108 and the glass-air exit interface 109 of the glass rod insert 104. Because the interfaces 107 and 108 are at angle to the optical fiber axis, the Fresnel reflected light will not couple back into the fiber. Furthermore at the interface 109, the beam diameter is very much larger the core diameter of the monomode fiber thus the amount of Fresnel reflected light that can couple back into the fiber is greatly reduced. It is reduced further by coating the interface 109 of the rod insert 104 with an antireflection coating. It is also recognized that the reflections at the interfaces 107 and 108 are eliminated by reducing the air gap to zero thickness, i.e. make optical contact between the end of the fiber tip 102 and the angled end of the rod insert 104.

Another embodiment of the invention is shown in FIG. 4 where the air gap is filled with an epoxy 110 that has a refractive index equal to n_{core}. In this embodiment, it is not necessary to have a mounting sleeve 103. The collimator holder 105 of FIG. 2 is provided with a hole of the appropriate diameter to hold and secure the structure depicted in FIG. 4, without the use of a mounting sleeve 103.

The addition of the glass rod insert 104 to the design of the laser collimator has several benefits. Firstly, the direction of the radiating cone of light emerging from the optical fiber tip 102 is straighten so that it propagates along the optic axis of the collimator. Consequently, the light passes through the center of the plano-convex lens 106 and the direction of the expanded parallel light beam is coincident with the laser collimator axis. Furthermore, because the light passes through rod insert 104 which has a refractive index higher than air, the effective focal length the plano-convex lens 106 is larger than the actually distance between the fiber tip and the plano-convex lens. Thus the curvature of the convex surface of this plano-convex lens 106 is lower than the equivalent lens required for a collimator in which the medium between the optical fiber tip and the lens is all air as in the collimator of FIG. 1. The plano-convex lens 106 of the invention is also simpler to manufacture than the lens 106a in the collimator of FIG. 1, because it has a smaller diameter and the plane surface of the lens 106 is normal to the optic axis. Finally the light on passing through the collimator will experience less aberrations because it passes through the center of the lens and the lens curvature is lower. In the embodiment of FIG. 3, the glass rod insert 104 has two surfaces 108 and 104 having respectively, angles of 82 and 90 degrees to the optic axis of the laser collimator. It is readily recognized by one skill in the art there other appropriate sets of angles which will accomplish this same goal of straightening out the deflected diverging cone of light emerging from the fiber tip and aligning its propagation direction parallel to the optic axis of the laser collimator. However the choice of angle for surface 108 that matches the angle for surface 107 on the optical fiber tip 102 is preferred because it enables the smallest size air gap between the two surfaces.

It will also be appreciated by one skilled in the art that more than one fiber could be included in the fiber pigtail 200. For example the fiber pigtail 200 could contain two fibers. The second fiber is used to launch visible light that is used as a pointer for lining up the collimator with the receiver. Once a signal is obtained, the alignment is fined tuned to maximize the received signal. The second fiber could also be used to transmit a signal on an optical carrier having a different wavelength. In this embodiment a dichroic filter or other wavelength separating means would be required in the receiver to separate the two wavelengths.

Another objective of the invention is to provide an optical fiber tip that radiates light into a larger acceptance angle, T_{acceptance} for the purpose of increasing the half angle of the cone of light emerging from the fiber tip 102. Such a fiber tip increases the beam diameter of the parallel light beam that is projected by the laser collimator without having to increase the collimator length thus enabling a laser collimator with a larger beam expansion in a compact size.

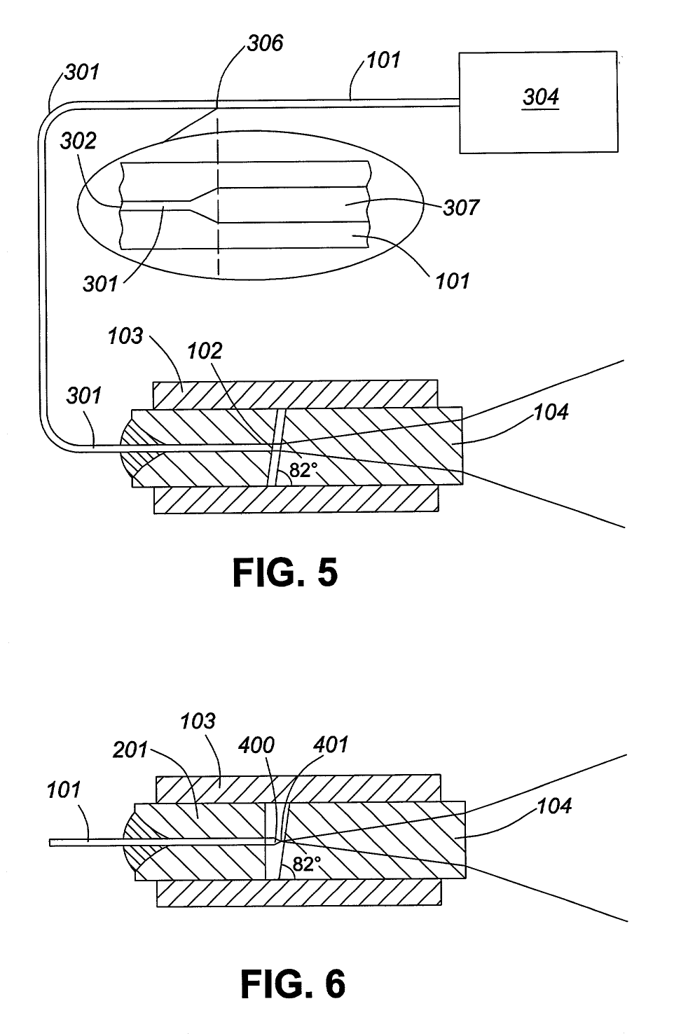

The acceptance angle is a property of the fiber and is related to the fiber numerical aperture, NA, and the refractive indices of the core and cladding through the expression NA={square root over ((n_{core}²)} n_{cadding}²)=sinT_{acceptance}. Thus the numerical aperture of the fiber is increased by increasing the difference between the core and cladding refractive index. In practice, this is usually accomplished by increasing the amount of dopant in the core during the manufacture of the fiber. Thus one approach for increasing the acceptance angle is to manufacture the fiber pigtail 200 using a special monomode fiber that has a larger numerical aperture. This embodiment of the invention is shown in FIG. 5 which shows only the sleeve 103 of the collimator in FIG. 2. The monomode fiber 101 in FIG. 3 has be replaced with a special monomode optical fiber 301 that has a higher core refractive index. The refractive index of the rod insert 104 is also larger in order to have the same refractive index as the fiber core of the specialty fiber 301. In this approach it is preferable to have the normalized frequency V=(Σd/O)NA of the specialty fiber 301 be nominally the same as the normalized frequency of the standard telecommunication fiber that is used to pigtail the semiconductor laser. This requirement can be satisfied for a monomode telecommunications fiber 101 and a monomode specialty fiber 301 that have respectively fiber core diameters of d and dₛ and numerical apertures of NA and NAₛ such that dₛ/NAₛ=d/NA. The numerical aperture of the specialty fiber 301 is greater than the numerical aperture of the telecommunications fiber by the ratio of the diameters d/dₛ. It is feasible to make a monomode specialty fiber 301 with half the diameter of the telecommunications; hence the numerical aperture is twice the size of the numerical aperture of the telecommunications fiber. The acceptance angle is correspondingly increased through the relationship sinT_{acceptance}=NAₛ. Using this approach it is feasible to double the acceptance angle and thus make a similar increase in the diameter of the projected laser beam. A practical issue is the connection of the monomode specialty fiber to the monomode fiber pigtail of the semiconductor laser. This is accomplished by thermally expanding the core of the specialty fiber as described in U.S. Pat. No. 6,275,627 and the references therein to match the mode field diameter of the monomode fiber pigtail of the semiconductor laser. The laser fiber pigtail can then be fusion spliced directly to thermally expanded core of the specialty fiber used in making the fiber pigtail. FIG. 5. shows the connection of the laser diode 304 with a pigtail that uses standard telecommunications monomode optical fiber 101 by a fusion splice 306 to the monomode specialty fiber 301. The inset in FIG. 5 provides an expanded view of the region about the fusion splice 306. It shows the diameter of the core 302 of the specialty fiber 301 is thermally expanded to match the diameter of the core 307 of the monomode fiber 101 at the point of the fusion splice. The problem with this approach for increasing acceptance angle of the cone of light radiating from the fiber tip 102 is that it requires a special fiber in the optical fiber pigtail 200.

Another approach for increasing the acceptance angle that does not require a specialty fiber is to form a taper on the end of standard monomode optical fiber. This can be accomplished using the techniques similar to that for the manufacture of fused biconical couplers. A few centimeters of bare fiber is placed under tension in a jig and the center is heated with a hydrogen torch. As the glass softens, the fiber elongates forming a biconical taper. The biconal taper is then cleaved near the center of the bicone thereby forming a fiber pigtail with a half bicone or a tapered end. Several conditions must be satisfied to form a suitable tapered optical fiber tip. Firstly, the taper is sufficiently gradual so that light propagating in the monomode fiber is not converted into radiation modes in the tapered section. Secondly, the fiber is tapered to small enough diameter so that the light propagating as a bound mode in the core of the fiber radiates into cladding and propagates as a bound mode in the tapered end structure that has air as its cladding and the glass of the fiber as its core. This condition is obtained when the diameter, d, of the fiber core becomes sufficiently small in the tapering process that the local normalized frequency V=(Σd/O)NA|1. FIG. 6 shows the fiber sleeve 103 of the laser collimator for this embodiment of the invention. The half bicone or tapered optical fiber tip 400 is shown protruding from the capillary tube 201 in which it is mounted. In general, the waveguide structure at the fiber tapered end 400 can be viewed a short circular glass rod waveguide with an air cladding and an angled surface exit end 401. Because the cladding is air, this fiber waveguide structure 400 has a high numerical aperture (NA|1.1). If the fiber waveguide structure 400 is to support only single mode propagation, the normalized frequency V 2.405 which implies the diameter of the fiber structure 400 is very small, of the order of the wavelength of the light O=1550 nm. It would be appreciated by one skilled in the art, that a fiber waveguide structures 400 that have a larger diameter could be used. This is possible even though the normalized frequency V! 2.405 and the fiber structure 400 is a multimode waveguide since only the lowest order mode of the waveguide structure is excited as the light propagates from the single mode fiber into the fiber waveguide structure 400. In this case, however, the half-angle of the radiated light cone from the fiber tip will not be related to the numerical aperture but will depend on the propagation characteristics of the lowest order mode in the fiber waveguide structure 400. A practical issue is how to package of the fiber tip. It will be necessary to have the of the fiber waveguide structure project out of the capillary tube holder 201 into the air for a short distance. This will place a limitation on the length of the fiber waveguide structure 400. Since the fiber waveguide structure 400 is formed primarily from the cladding glass of the monomode fiber 101, the rod insert 104 has a refractive index nominally equal to the refractive index of the cladding of the optical monomode fiber 101. It also recognized by one skilled in the art, that the end 401 of the fiber waveguide structure 400 could make optical contact with the glass rod insert and that epoxy of suitable refractive index could be used to fasten the fiber waveguide structure 400 to the rod insert 104.

What is claimed is:

1 A laser collimator for substantially collimating a beam of light, comprising:
an optical fiber having a cladding bounding a core, said optical fiber having an input end for receiving laser light and a slanted output end for transmitting said light;
a lens for substantially collimating an input beam of light received from the output end of the optical fiber;
a light transmissive element so located and oriented between the optical fiber output end and the lens for correcting an angular deviation in the beam of light exiting the slanted output end.

2. A laser collimator as defined in claim 1, comprising an optical fiber sleeve holding the optical fiber, wherein the optical fiber sleeve and the optical fiber have parallel longitudinal axes and coplanar end surfaces, said end surfaces at a slant with respect to a plane perpendicular to said longitudinal axes.

3. A laser collimator as defined in claim 2, wherein the light transmissive element is a wedge.

4. A laser collimator as defined in claim 3 wherein the wedge has a slanted surface that is substantially parallel with and facing slanted end surface of the optical fiber.

5. A laser collimator as defined in claim 4 wherein the wedge has an output end surface opposite the slanted surface that is substantially normal to the longitudinal axis of the optical fiber sleeve.

6. A laser collimator as defined in claim 5, wherein the wedge and the sleeve are held securely within an outer sleeve, and wherein the lens and the outer sleeve are relatively immovable.

7. A laser collimator as defined in claim 6, wherein the lens is one of affixed to an end of the outer sleeve; and, held securely within the sleeve.

8. A laser collimator as defined in claim 1, wherein the light transmissive element has two non-parallel surfaces, and wherein the element has a refractive index that is substantially equal to the refractive index of the optical fiber core.

9. A laser collimator as defined in claim 1, wherein the optical fiber output end has a numerical aperture greater than the numerical aperture of the input end.

10. A laser collimator as defined in claim 1 wherein the optical fiber core about the output end that has a diameter of less than the core about the input end for lessening the mode field diameter of a beam exiting the output end and increasing the numerical aperture of the fiber to thereby increase divergence of said exiting beam.

11. A laser collimator as defined in claim 2, wherein the light transmissive element is substantially absent optical power.

12. A laser collimator for substantially collimating a beam of light, comprising:
an optical fiber having a cladding bounding a core, said optical fiber having an input end for receiving laser light and a slanted output end for transmitting said light;
an optical fiber sleeve holding the optical fiber, wherein the optical fiber sleeve and the optical fiber have parallel longitudinal axes and coplanar end surfaces, said end surfaces at a slant with respect to a plane perpendicular to said longitudinal axes;
a lens for substantially collimating an input beam of light received from the output end of the optical fiber;
a light transmissive element having a first light receiving face and an opposed light transmitting face, said receiving and transmitting faces being non-parallel, the light transmissive element so located and oriented between the optical fiber output end and the lens so as to correct an angular deviation in the beam of light exiting the slanted output end; and, a laser optically coupled with the input end of the optical fiber.

13. A laser collimator as defined in claim 13, wherein the laser includes a pigtailed optical fiber for coupling with the optical fiber, and wherein the light transmissive element is a wedge having essentially no optical power.
